(19) United States
(12) Patent Application Publication
(10) Pub. No.: US 2026/0268291 A1
(43) Pub. Date: Sep. 10, 2026

(54) Systems and Methods for a Structured Referral Platform Utilizing Referral Card Data Structures

(71) Applicant: ACCELETREX CORPORATION, Miami, FL (US)

(72) Inventors: Mark Townsend, Madbury, NH (US); Gene Thomas Massuci, Mooresville, NC (US); Allan Thompson, Ponte Vedra, FL (US)

(21) Appl. No.: 19/562,260

(22) Filed: Mar. 10, 2026

Related U.S. Application Data
(60) Provisional application No. 63/769,488, filed on Mar. 10, 2025.

(51) Int. Cl. G06Q 10/40

(52) U.S. Cl. CPC G06Q 10/40

(57) ABSTRACT

A referral platform is described for generating and identifying vendor referrals using referral card data structures. The platform stores referral cards created by users that define requests for vendor solutions and include attributes describing the request and identifying a referral card creator. Referral cards are associated with vendor solutions and organized according to market sectors within a data storage system. When a request for a vendor solution is received, the platform searches the stored referral cards to identify vendor solutions corresponding to the request. A referral score is determined for each referral card based on attributes stored in the referral card data structures, including a credibility weighting associated with the referral card creator. Vendor solutions and associated referral cards are provided as ranked results based on the referral scores, enabling users to identify vendor solutions and referral contacts capable of facilitating access to the vendor solutions.

### CROSS-REFERENCE TO RELATED APPLICATIONS

This application claims the benefit of U.S. Provisional Application No. 63/769,488, filed Mar. 10, 2025, the entire contents of which are incorporated herein by reference.

### BACKGROUND

There are a number of different online platforms through which people can interact and/or conduct business. Social media platforms provide the technology and digital infrastructure to share content and connect with others in a virtual environment; e-commerce platforms provide the technology and digital infrastructure to support online shopping, where a business can process payments and sell goods and services over the Internet; and gig platforms provide the technology and digital infrastructure to connect people looking for work with people who want to hire them, as some examples. While these platforms enable digital interaction and transaction, they typically rely on direct searches, listings, or marketplace-style interactions rather than leveraging referral knowledge or relationships that may exist among individuals within an organization or network.

Even with this environment of various digital services, it can still be challenging to find and connect with people and businesses to obtain a desired product or service using the current digital infrastructure. In particular, organizations often possess internal knowledge regarding trusted contacts, vendors, or service providers that have previously been used or recommended, but this information is frequently distributed across individuals and informal communications rather than being captured in a structured system that can be searched and evaluated. As a result, users attempting to identify suitable vendors or solutions may be unable to efficiently locate relevant referrals, identify trusted contacts associated with those referrals, or evaluate potential solutions based on prior referral experience or credibility of the referring individual.

### BRIEF SUMMARY

Systems and methods for a structured referral platform utilizing referral card data structures are described herein. The structured referral platform can capture referral information associated with requests for vendor solutions and organize that information in referral card data structures that include attributes describing the request and identifying a referral source such as a referral card creator or a referral contact. The referral cards may be associated with vendor solutions and organized according to market sectors to enable users of the platform to identify potential vendor solutions based on previously generated referrals.

In certain embodiments, referral cards generated by users of the platform may be stored and later searched by other users seeking vendor solutions. The referral platform may evaluate referral cards associated with vendor solutions using one or more attributes stored in the referral card data structures, including identifiers associated with referral card creators or referral contacts. Vendor solutions may then be identified and presented based on the stored referral information, allowing users to locate vendor solutions and associated referral contacts that may facilitate access to the vendor solutions.

In some aspects, a referral platform is described for generating and identifying vendor referrals utilizing referral card data structures, the referral platform includes: a processing system including one or more processors and one or more computer-readable storage media; and a data storage system storing vendor solutions and referral cards, wherein instructions stored on the one or more computer-readable storage media, when executed by the processing system, cause the referral platform to: generate referral cards by receiving input associated with a referral card creator defining requests for vendor solutions, each referral card including a data structure including a plurality of attributes associated with a corresponding request for a vendor solution and an identifier of the referral card creator; associate the referral cards with vendor solutions stored in the referral platform based on at least one market sector of a plurality of market sectors identified from one or more attributes stored in the referral card data structures; store the referral cards and associated vendor solutions in the data storage system indexed according to the plurality of market sectors; in response to subsequent requests for vendor solutions, search the stored referral cards indexed in the data storage system according to the plurality of market sectors to identify vendor solutions associated with referral cards corresponding to the requests; determine, for each of the referral cards identified from the searching, a referral score based on one or more attributes stored in the referral card data structures, including applying a credibility weighting associated with the identifier of the referral card creator; and provide the identified vendor solutions and associated referral cards ranked according to the referral scores.

In some aspects, a computer-implemented method is described for generating vendor referrals in a structured referral platform utilizing referral card data structures. The method includes: receiving input associated with a referral card creator defining a request for a vendor solution; generating a referral card based on the received input, the referral card including a data structure including a plurality of attributes associated with the request for the vendor solution and an identifier of the referral card creator; identifying, based on one or more attributes stored in the referral card data structure, a market sector associated with the request for the vendor solution; associating the referral card with vendor solutions stored in the referral platform based on the identified market sector; storing the referral card and the associated vendor solutions in a data storage system indexed according to a plurality of market sectors; and storing one or more attributes associated with the referral card creator in the referral card data structure for use in determining a credibility weighting applied to the referral card during subsequent identification of vendor referrals.

In some aspects, a computer-implemented method is described for identifying vendor referrals in a structured referral platform utilizing referral card data structures. The method includes: receiving input defining a request for a vendor solution; identifying, based on one or more attributes associated with the request for the vendor solution, a market sector of a plurality of market sectors indexed in a data storage system of the referral platform; searching referral cards stored in the data storage system and indexed according to the plurality of market sectors to identify referral cards associated with vendor solutions corresponding to the request for the vendor solution; determining, for each of the referral cards identified from the searching, a referral score based on one or more attributes stored in the referral card data structures, including applying a credibility weighting associated with an identifier of a referral card creator associated with each referral card; and providing vendor solutions associated with the identified referral cards ranked according to the referral scores.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates components of a referral platform.

FIG. 2A illustrates example search and matching functionality performed by the referral platform.

FIG. 2B illustrates example referral card generation operations that may be performed by the referral platform in response to user actions.

FIG. 3A illustrates an example process flow that may be performed by the referral platform for identifying vendor solutions associated with a request.

FIG. 3B illustrates an example process flow associated with generation, storage, and use of referral cards within the referral platform.

FIG. 3C illustrates an example process flow associated with generation of referral cards within the referral platform.

FIG. 3D illustrates an example process flow associated with identifying vendor referrals using referral cards stored within the referral platform.

FIG. 4A illustrates an example referral creation interface.

FIG. 4B illustrates an example user interface including a search bar.

FIG. 4C illustrates an example results page.

FIG. 4D illustrates a referral creation page that may be displayed as a result of selecting the “select” command button of FIG. 4C.

FIG. 4E illustrates an example user interface including fields for entering refinements to a search request.

FIG. 5 illustrates a visual representation of an example referral card interface which can trigger referral card generation and/or search.

### DETAILED DESCRIPTION

In contrast to conventional online search platforms or marketplace systems that rely primarily on keyword searches or static vendor listings, the systems and methods described herein provide a structured referral platform that captures referral information associated with requests for vendor solutions in referral card data structures. Each referral card may include attributes describing a request for a vendor solution as well as identifiers associated with individuals capable of facilitating access to the vendor solution. By storing referral information in structured referral card data structures, the platform enables referral knowledge that may otherwise exist across individual users or informal communications to be captured in a form that can be searched, evaluated, and reused by other users of the platform.

In some embodiments, referral cards may be associated with vendor solutions and organized within a data storage system according to market sectors. Organizing referral cards and associated vendor solutions by market sector enables the referral platform to identify vendor solutions relevant to subsequent requests for vendor solutions. In this manner, the referral platform can search previously generated referral cards corresponding to a request and identify vendor solutions associated with those referral cards.

In certain embodiments, referral cards associated with vendor solutions may be evaluated based on attributes stored within the referral card data structures. For example, the referral platform may determine referral scores associated with referral cards using attributes that include identifiers of referral card creators or referral contacts. The referral scores may incorporate credibility weightings associated with those identifiers or other attributes stored in the referral card data structures. Vendor solutions associated with the referral cards may then be presented to users and ranked according to the determined referral scores.

In some implementations, the structured referral card data structures and associated indexing mechanisms described herein improve the operation of computer systems used to store, retrieve, and evaluate referral information. By organizing referral information using structured data attributes and sector-based indexing, the referral platform enables more efficient computer-implemented searching, scoring, and retrieval of vendor solutions than conventional unstructured search or marketplace systems.

Accordingly, the structured referral platform described herein enables users seeking vendor solutions to identify vendor solutions and associated referral contacts using stored referral information generated by other users of the platform. By organizing referral cards according to market sectors and evaluating referral cards using attributes associated with referral sources, the referral platform provides an improved mechanism for identifying vendor solutions and facilitating connections between users and vendors. Example implementations of the referral platform and associated components are described below with reference to the accompanying figures.

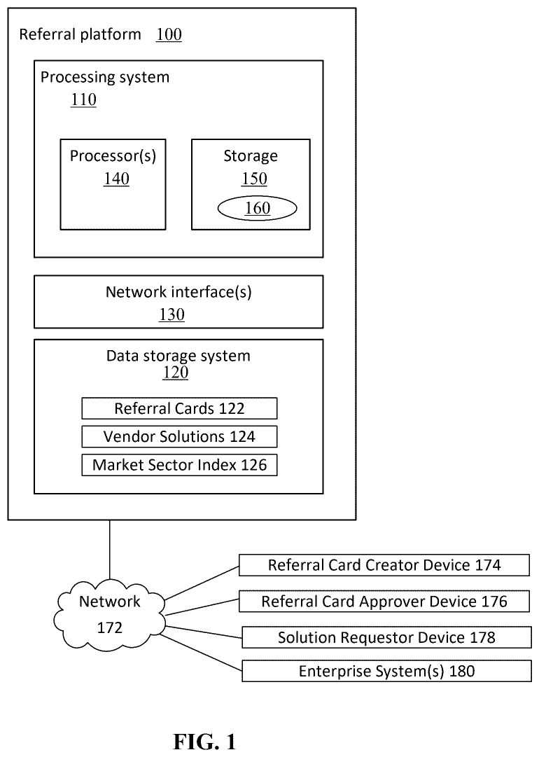

FIG. 1 illustrates components of a structured referral platform utilizing referral card data structures. Referring to FIG. 1, a referral platform 100 includes a processing system 110 and a data storage system 120. Referral platform 100 also includes network interfaces 130, which enable network communication to and from the referral platform 100. Through the network interfaces 130, the referral platform 100 may communicate over a network 172 with external devices and systems including, for example, a referral card creator device 174, a referral card approver device 176, a solution requestor device 178, and one or more enterprise systems 180. Enterprise systems 180 can include, for example, contact management systems, vendor relationship management systems, customer relationship management systems, or other enterprise information systems that store information associated with vendors, referral contacts, or organizational users. Application programming interfaces (APIs) can also be supported for communications between components of the referral platform and between the referral platform and other systems.

In some implementations, the referral platform 100 may integrate with enterprise information systems used within an organization to manage contacts, vendors, or business relationships. For example, enterprise systems 180 may maintain information associated with vendor organizations, contact persons, prior transactions, or organizational relationships. The referral platform 100 may obtain or synchronize information from such enterprise systems to populate attributes of referral card data structures, including identifiers associated with referral contacts or organizations associated with vendor solutions. In some implementations, integration with enterprise systems 180 may be performed through application programming interfaces (APIs), data synchronization services, or other communication mechanisms that allow referral information maintained within the referral platform to be used in conjunction with existing enterprise business systems. In certain embodiments, the features and processes described herein may be integrated into such enterprise systems to extend functionality of the enterprise systems to include generation, storage, and searching of referral card data structures.

As used herein, a “referral card” (e.g., one of the referral cards 122) refers to a structured data record maintained by the referral platform that stores information associated with a request for a vendor solution and one or more referral sources capable of facilitating access to the vendor solution. A referral card may include a data structure comprising a plurality of attributes describing the request for the vendor solution, identifiers (including, in some implementations a tagged identifier) associated with a referral card creator or referral contact person, and information associated with one or more vendor solutions related to the request. In some implementations, referral cards may further include attributes such as a description of a problem to be solved, timeline or budget information, organizational roles associated with a request, or other contextual information associated with the request for the vendor solution. Referral cards may be stored, indexed, searched, and evaluated by the referral platform to identify vendor solutions and associated referral contacts.

A “vendor solution” (e.g., one of the vendor solutions 124) refers to a product, service, technology, capability, or other offering provided or made available by a vendor organization that may satisfy or address a request represented in a referral card. Vendor solutions may be associated with one or more vendors, organizations, or service providers and may include associated information such as vendor identifiers, organizational information, geographic information, company stage information, project stage information, or other attributes describing the vendor or the offering provided by the vendor. Vendor solutions may be associated with one or more referral cards within the referral platform to enable identification of vendor solutions based on previously generated referrals.

A “market sector” refers to a category or classification used by the referral platform to organize vendor solutions and referral cards according to areas of business activity, technology domains, industry segments, or other logical groupings associated with vendor solutions. Market sectors may be determined based on attributes stored in referral card data structures, attributes associated with vendor solutions, or other classification information maintained by the referral platform. In some implementations, identification of a market sector associated with a request for a vendor solution may be performed using topic analysis, keyword analysis, or other techniques applied to attributes stored in referral card data structures.

A “market sector index” (e.g., market sector index 126) refers to a data structure or indexing structure maintained by the referral platform that organizes vendor solutions and referral cards according to market sectors to facilitate efficient searching and retrieval. The market sector index may associate vendor solutions and referral cards with one or more market sectors and may be used by the referral platform to limit or guide searches for vendor solutions corresponding to a request represented in a referral card. In some implementations, the market sector index may include lookup structures, classification tables, or other indexing mechanisms used to identify vendor solutions or referral cards associated with a particular market sector.

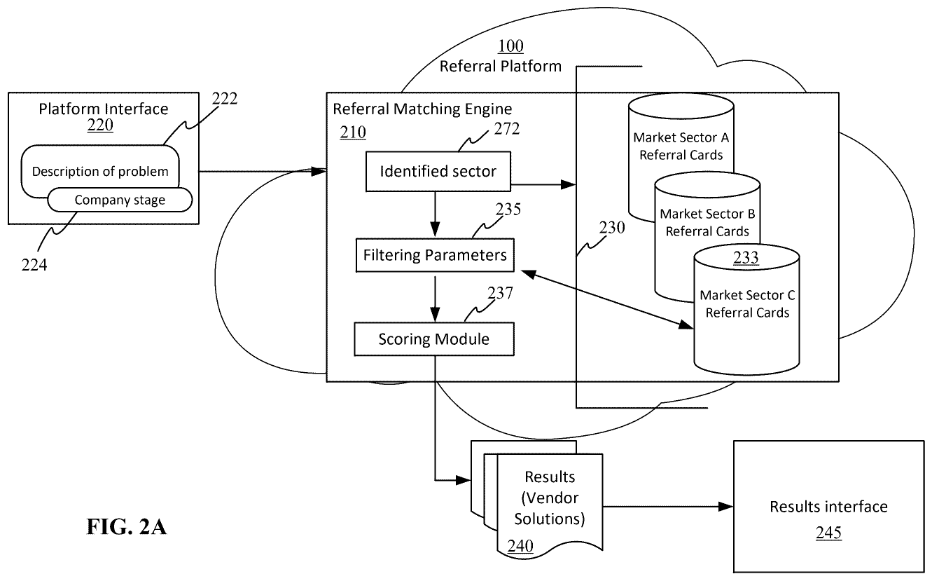

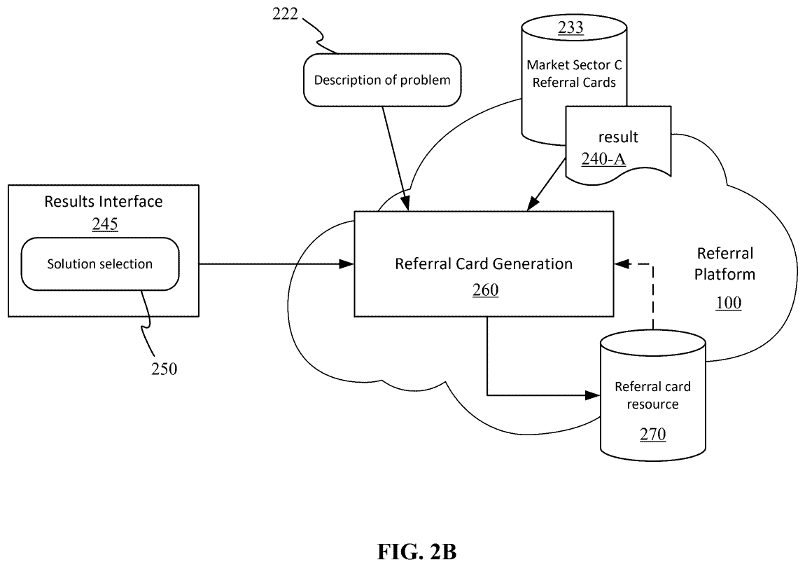

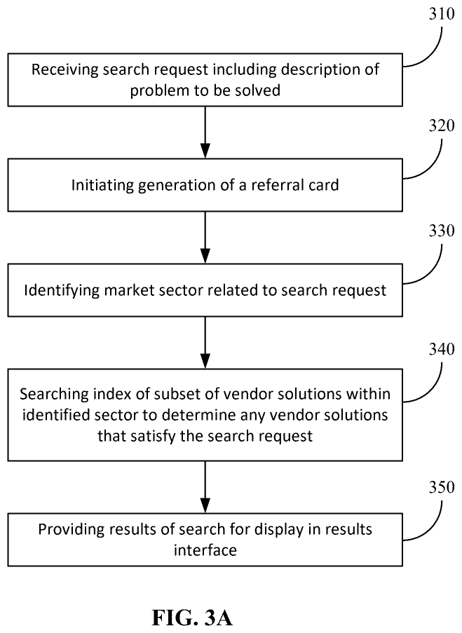

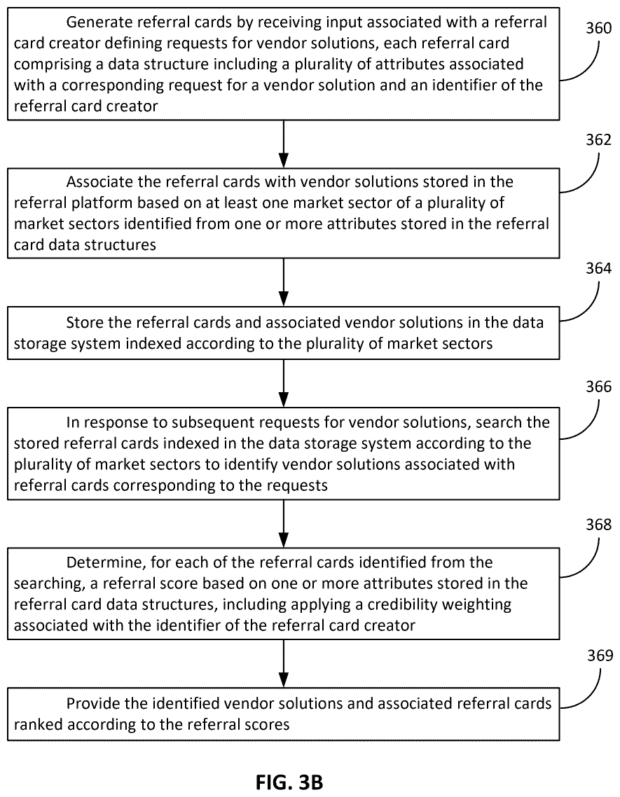

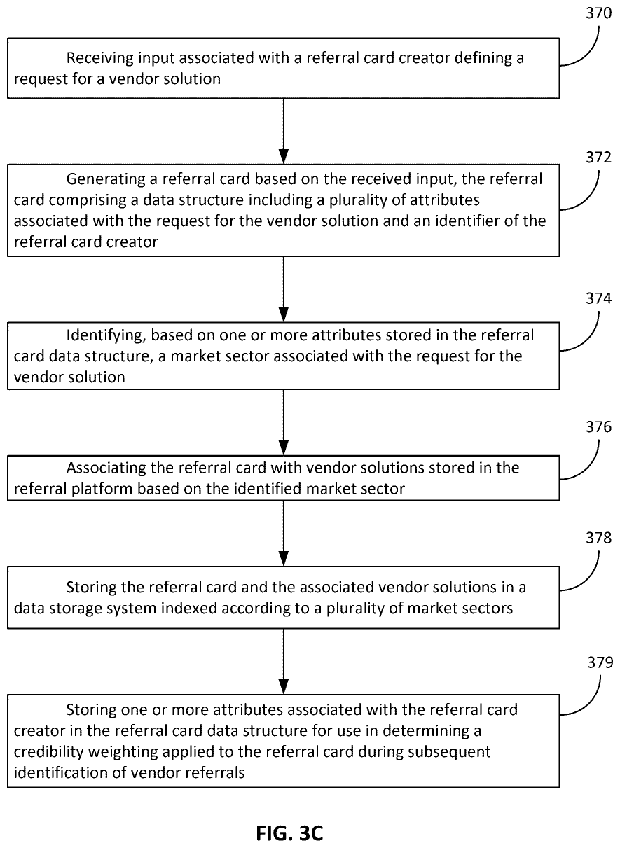

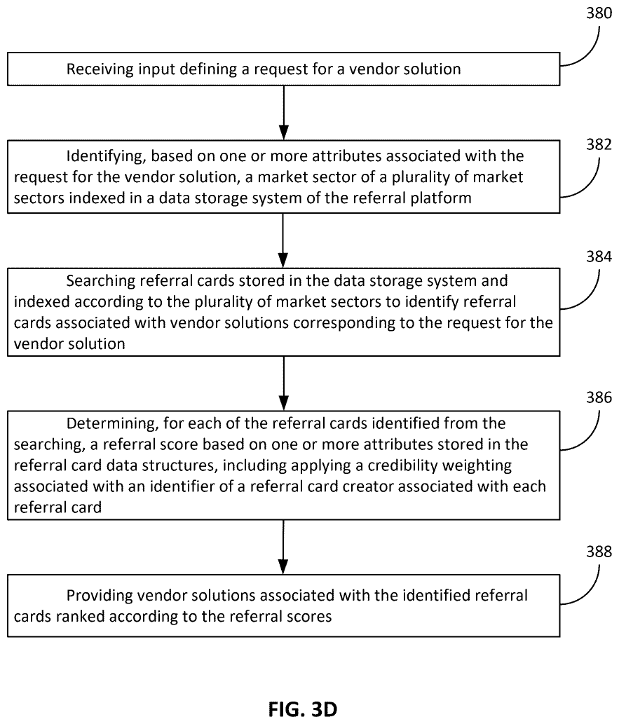

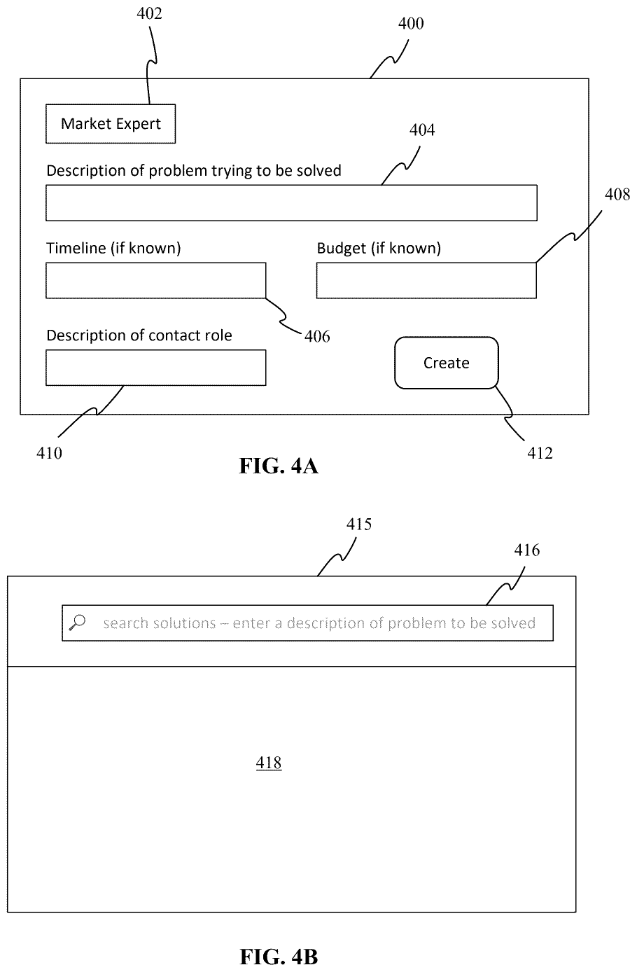

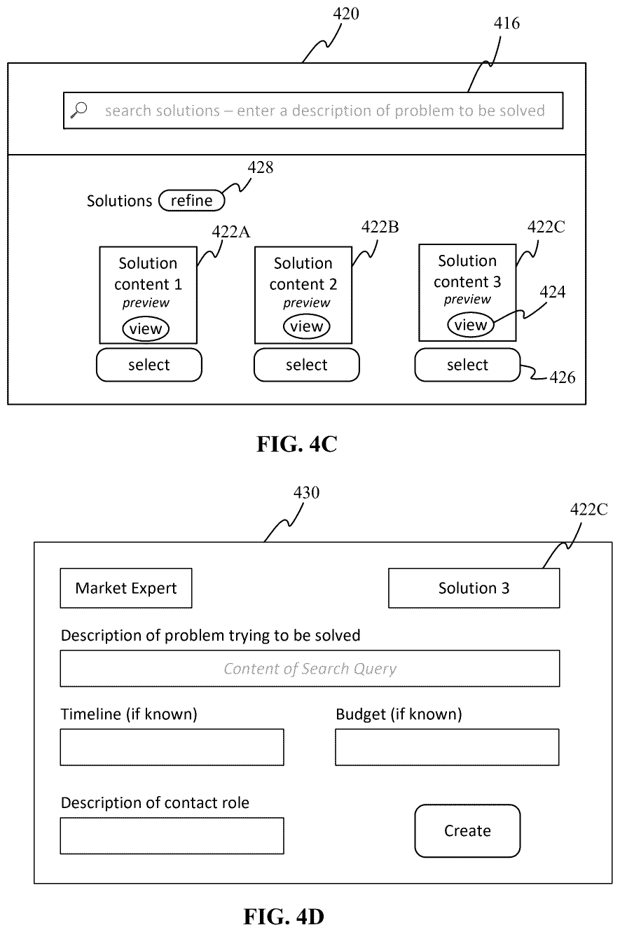

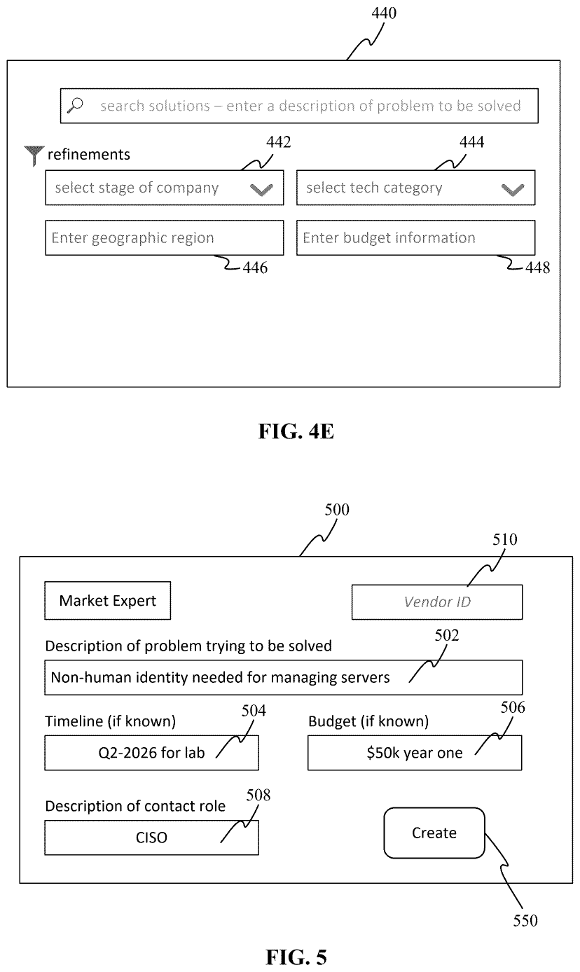

A “processing system” refers to a computer or a cluster of computers used to carry out processes. A processing system includes one or more processors 140 and one or more computer-readable storage media (or “storage” 150). Instructions 160 for carrying out operations as described herein can be stored at storage 150 and when executed by at least one of the one or more processors 140 direct the referral platform 100 to connect market experts with vendors for referrals to a potential buyer of a vendor solution, including, but not limited to, operations and functionality described with respect to FIGS. 2A, 2B, 3A, 3B, 3C, and 3D, as well as various user interfaces for referral card creators and vendors that can be provided (see e.g., example representations of FIGS. 4A-4E and 5). As provided in detail herein, the referral platform 100 can implement a search engine and perform referral card generation.

A “data storage system” refers to one or more storage media and the components supporting storage and retrieval of data at the storage media (e.g., read circuitry, write circuitry, and memory controllers, as some examples). “Computer-readable storage media” and “storage media” refer to the physical devices on which data is stored and can include memory chips, disk drives, and the like. As used herein, “computer-readable storage media” and “storage media” do not consist of propagating signals or carrier waves.

Processing system 110 and data storage system 120 can be communicatively coupled so that the processing system 110 can receive input from the data storage system 120 as needed and can save output created based on the received input back to the data storage system 120 (which provides the source of the input data) or to other storage locations that may be, but are not limited to be, part of the data storage system. Both the processing system and the data storage system may be on a network (including cloud, remote, and on-premises options as non-limiting examples).

Input to the referral platform 100 can be from connected systems, via APIs, automatically generated, and/or user entered for generation or searching of referral cards 122. Users of the referral platform 100 can interact with the referral platform in various ways, including through user interfaces associated with the referral platform, as well as through various communication channels (e.g., messaging, email, etc.).

FIGS. 2A and 2B illustrate example operations of the referral platform including vendor solution identification and referral card generation. FIG. 2A illustrates example search and matching functionality performed by the referral platform, and FIG. 2B illustrates example referral card generation operations that may be performed by the referral platform in response to user actions.

Referring to FIG. 2A, referral platform 100 (for example via processing system 110 can implement a referral matching engine 210 that provides search functionality for identifying vendor solutions associated with stored referral information. The referral matching engine 210 may receive input through a platform interface 220 that enables users of the referral platform to submit requests for vendor solutions.

For example, the platform interface 220 may receive input including a description 222 of a problem to be solved and, in some implementations, additional attributes such as company stage information 224 associated with an organization seeking a vendor solution. The platform interface 220 can enable user input and can provide commands that trigger operations by the referral platform 100, including operations performed by the referral matching engine 210.

Based on received input, the referral matching engine 210 may identify a market sector 272 associated with the request. For example, identification of the market sector 272 may be based on analysis of the description of the problem to be solved 222 or other attributes associated with the request. In some implementations, identification of the market sector may include performing topic analysis or keyword analysis of the received description. In other implementations, a user may explicitly select a market sector through the platform interface 220, for example using a selectable list, checkbox, or other interface control.

The referral matching engine 210 may then search referral cards associated with vendor solutions stored in the referral platform according to the identified market sector. As illustrated in FIG. 2A, the referral platform may maintain referral cards organized by market sector (e.g., market sector A, market sector B, market sector C) within a storage resource. By identifying a particular market sector associated with the request, the referral platform may limit searching to referral cards and vendor solutions associated with that sector.

In some implementations, the referral matching engine 210 may apply one or more filtering parameters 235 to refine search results or calibrate vendor solutions identified during searching. Filtering parameters may include attributes associated with the request or attributes associated with vendor solutions. For example, filtering parameters may include company stage, technology category, geographic location, reputation indicators, or other characteristics associated with vendors or vendor solutions.

A scoring module 237 may evaluate referral cards associated with vendor solutions identified during searching. In some implementations, the scoring module 237 may determine referral scores for referral cards based on attributes stored in referral card data structures, including identifiers associated with referral card creators or referral contact persons. The scoring module may apply credibility weightings associated with referral sources when determining referral scores.

Results 240 corresponding to vendor solutions identified through the referral matching process may be provided by the referral platform for display within a results interface 245. The results interface 245 may present vendor solutions and associated referral information to users of the referral platform. An example of a results interface 245 is illustrated in FIG. 4C.

Referring to FIG. 2B, the referral platform 100 may also perform referral card generation operations. In some implementations, a user may select a vendor solution from the results interface 245 (e.g., step 350). In response to the selection, the referral platform may initiate referral card generation 260.

Referral card generation 260 may create or update a referral card associated with the request. For example, the referral card may include information associated with the description of the problem to be solved 222 as well as information identifying a selected vendor solution. Referral cards generated by the referral platform may be stored within a referral card resource 270.

In some implementations, referral card generation may also utilize information stored within the referral platform, including referral cards associated with particular market sectors 230. For example, referral cards stored in market sector storage 233 may provide information associated with previously generated referrals that may be used to populate or update attributes of newly generated referral cards.

As used herein, a “referral matching engine” (e.g., referral matching engine 210) refers to a component of the referral platform configured to identify vendor solutions associated with stored referral information. The referral matching engine may analyze input associated with a request for a vendor solution, identify a market sector associated with the request, search referral cards stored by the referral platform, and provide vendor solutions corresponding to the request. In some implementations, the referral matching engine may coordinate operations including sector identification, filtering of candidate vendor solutions, and scoring of referral cards. “Filtering parameters” (e.g., filtering parameters 235) refer to attributes or criteria applied by the referral platform to refine identification of vendor solutions during searching. Filtering parameters may include attributes associated with a request for a vendor solution, attributes associated with vendor organizations, or attributes associated with vendor solutions. Non-limiting examples of filtering parameters include company stage, geographic location, technology category, reputation indicators, project stage, or other characteristics associated with vendors or vendor solutions.

A “referral score” refers to a value determined by the referral platform that represents a relative likelihood that a referral card may successfully facilitate access to a vendor solution corresponding to a request. Referral scores may be determined using attributes stored in referral card data structures, including attributes associated with referral card creators, referral contact persons, or other referral sources. Referral scores may be used by the referral platform to rank vendor solutions identified during searches.

A “credibility weighting” refers to a weighting value associated with a referral source that influences determination of a referral score. Credibility weightings may be associated with identifiers of referral card creators, referral contact persons, or other referral sources and may reflect factors such as prior referral outcomes, historical interactions with vendors, organizational relationships, or other attributes stored in referral card data structures.

Referring to FIG. 2B, the referral platform 100 (for example via processing system 110) performs referral card generation operations. As described above, information used by the referral platform 100 may be stored in referral cards that include structured data associated with requests for vendor solutions. For example, a referral card may include information associated with a description of a problem to be solved 222 as well as additional attributes associated with the request. Referral cards generated by the referral platform may be stored within a referral card resource 270.

In some implementations, referral cards may be created, updated, or modified as users interact with the referral platform. For example, the referral platform may generate a new referral card based on received request information or may update an existing referral card as additional information becomes available. In other implementations, updated information may be stored in a new referral card instance while prior versions are retained or archived.

A referral card data structure may include various attributes associated with the request for the vendor solution. Non-limiting examples of attributes that may be included in a referral card include identifiers associated with a referral card creator, identifiers associated with referral contacts capable of facilitating access to a vendor solution, descriptions of contact roles associated with those contacts, and contextual information such as timeline or budget information associated with the request.

As illustrated in FIG. 2B, a user may select a vendor solution from results presented within a results interface 245. For example, the results interface 245 may present vendor solutions identified during referral matching operations (e.g., results 240), and a user may select a vendor solution 240-A through a solution selection control 250. The selected vendor solution may then be received by the referral platform 100 and used as part of referral card generation operations.

In some implementations, referral card generation 260 may include creating a new referral card or updating an existing referral card to include information associated with the selected vendor solution. For example, the referral card may be updated to include an identifier associated with the vendor organization or vendor solution corresponding to the selected result.

In some implementations, the referral platform 100 may prompt a user to provide additional information associated with the referral card after a vendor solution has been selected. For example, the referral platform may request additional attributes associated with the request for the vendor solution, referral contact information, or other contextual information associated with the request.

Once sufficient information has been included in the referral card data structure, the referral card may be stored within the referral platform for use in subsequent referral identification operations. In some implementations, the referral platform may also notify a vendor organization or vendor contact associated with the vendor solution represented in the referral card.

In some situations, a vendor organization may receive multiple referrals associated with a same potential customer or request. For example, different referral cards may identify different referral contacts within a customer organization, or different referral cards may be generated by different referral card creators associated with the referral platform. The referral platform may evaluate such referrals using scoring or weighting techniques that consider attributes associated with the referral cards.

In some implementations, referral scoring may consider attributes such as identifiers associated with referral sources, contact roles associated with referral contacts, timeline or budget attributes associated with the request, or other contextual attributes stored within referral card data structures. Vendor-related attributes such as vendor availability or capability may also be considered when evaluating referrals.

Referral scoring or weighting operations may be implemented using any suitable technique. In some implementations, the referral platform may obtain feedback associated with prior referrals, such as feedback from vendors regarding referral outcomes. Such feedback may be used to adjust credibility weightings associated with referral sources or other scoring parameters used by the referral platform.

FIG. 3A illustrates an example computer-implemented process flow that may be performed by the referral platform for identifying vendor solutions associated with a request. The process flow may be performed by the referral platform 100, for example through execution of instructions by the processing system 110 and components such as the referral matching engine described above.

At step 310, the referral platform receives a search request that includes a description of a problem to be solved. The search request may be received through a platform interface that enables users of the referral platform to submit requests for vendor solutions. The description of the problem to be solved may correspond to a request for identifying one or more vendor solutions capable of addressing the described problem.

At step 320, the referral platform may initiate generation of a referral card associated with the request. As described above, referral cards may be used by the referral platform to store structured information associated with requests for vendor solutions. In some implementations, initiation of the referral card may occur when the request is received, and the referral card may be updated as additional information associated with the request becomes available.

At step 330, the referral platform identifies a market sector associated with the request. Identification of the market sector may be based on analysis of the description of the problem to be solved or other attributes associated with the request. For example, the referral platform may perform keyword analysis, topic analysis, or other classification techniques to determine a market sector corresponding to the request.

At step 340, the referral platform searches vendor solutions associated with the identified market sector to determine vendor solutions that may satisfy the request. In some implementations, the referral platform may search an index of vendor solutions or referral cards organized according to market sectors, such as the market sector index described above.

At step 350, the referral platform provides results corresponding to vendor solutions identified during the search. The results may be presented through a results interface that enables a user of the referral platform to review potential vendor solutions and optionally select a vendor solution for further interaction with the referral platform.

FIG. 3B illustrates an example process flow associated with generation, storage, and use of referral cards within the referral platform. The process flow may be performed by the referral platform 100, for example through execution of instructions by the processing system 110 and interaction with data stored in the data storage system 120.

At step 360, the referral platform generates referral cards by receiving input associated with a referral card creator defining requests for vendor solutions. As described above, the referral card creator may provide information describing a request for a vendor solution, such as a description of a problem to be solved, organizational context associated with the request, or other attributes associated with the request. Each referral card may include a data structure comprising a plurality of attributes associated with the request for the vendor solution and an identifier associated with the referral card creator.

In some implementations, the referral card data structure may further include identifiers associated with referral contacts capable of facilitating access to a vendor organization, descriptions of contact roles associated with those contacts, and contextual attributes such as timeline information, budget information, or other attributes associated with the request.

At step 362, the referral platform associates referral cards with vendor solutions stored in the referral platform based on at least one market sector of a plurality of market sectors identified from one or more attributes stored in the referral card data structures. For example, the referral platform may analyze attributes of the referral card, such as the description of the problem to be solved or other contextual attributes, to identify a market sector associated with the request. Vendor solutions associated with the identified market sector may then be associated with the referral card.

In some implementations, vendor solutions stored within the referral platform may include associated attributes such as geographic location, company stage, project stage, or other information associated with vendor organizations.

At step 364, the referral platform stores the referral cards and associated vendor solutions within the data storage system indexed according to a plurality of market sectors. For example, the referral platform may maintain a market sector index that associates referral cards and vendor solutions with particular market sectors to facilitate efficient searching and retrieval.

In some implementations, referral cards may be stored such that they are searchable and retrievable by users of the referral platform other than the referral card creator.

At step 366, in response to subsequent requests for vendor solutions, the referral platform searches stored referral cards indexed according to the plurality of market sectors to identify vendor solutions associated with referral cards corresponding to the requests. For example, a user of the referral platform may submit a request for a vendor solution through the platform interface, and the referral platform may identify referral cards corresponding to the request based on attributes of the request and associated market sectors.

At step 368, the referral platform determines a referral score for each of the referral cards identified during the searching. The referral score may be determined based on one or more attributes stored in the referral card data structures. In some implementations, determining the referral score may include applying a credibility weighting associated with an identifier of a referral card creator or other referral source associated with the referral card. In certain embodiments, when a plurality of referral cards correspond to a same request for a vendor solution, the referral platform compares the referral scores and identifies a referral card having a highest likelihood of success in facilitating the vendor solution.

In some implementations, credibility weightings associated with referral sources may be adjusted based on feedback associated with prior referrals, including feedback received from vendor organizations regarding outcomes of previous referral interactions.

At step 369, the referral platform provides vendor solutions associated with the identified referral cards ranked according to the determined referral scores. The referral platform may present the vendor solutions and associated referral information through a results interface that enables users to review potential vendor solutions and identify referral contacts capable of facilitating access to those vendor solutions.

In some implementations, the referral platform may obtain or synchronize information associated with vendors or referral contacts from external enterprise systems, such as contact management systems, vendor relationship management systems, or customer relationship management systems.

FIG. 3C illustrates an example process flow associated with generation of referral cards within the referral platform. The process flow may be performed by the referral platform 100, for example through execution of instructions by the processing system 110 and interaction with the data storage system 120.

At step 370, the referral platform receives input associated with a referral card creator defining a request for a vendor solution. The input may include information describing a problem to be solved, contextual information associated with an organization requesting the vendor solution, or other attributes associated with the request. The input may be received through a platform interface or other communication mechanism that enables users to interact with the referral platform.

At step 372, the referral platform generates a referral card based on the received input. As described above, a referral card may include a data structure comprising a plurality of attributes associated with the request for the vendor solution and an identifier associated with the referral card creator. The referral card data structure may include attributes describing the request, contextual attributes associated with the requesting organization, and identifiers associated with referral sources capable of facilitating access to a vendor solution.

In some implementations, the referral card data structure may include additional attributes such as a description of a problem to be solved, timeline information associated with the request, budget information associated with the request, or information describing a role of a contact person associated with the requesting organization, the attributes being usable in associating the referral card with vendor solutions stored in the referral platform.

At step 374, the referral platform identifies a market sector associated with the request for the vendor solution based on one or more attributes stored in the referral card data structure. For example, identification of the market sector may be based on analysis of the description of the problem to be solved or other contextual attributes associated with the request. In some implementations, identification of the market sector may include performing topic analysis, keyword analysis, or other classification techniques applied to attributes stored in the referral card data structure.

At step 376, the referral platform associates the referral card with vendor solutions stored in the referral platform based on the identified market sector. Vendor solutions associated with the identified market sector may be identified using the market sector index described above and associated with the referral card to enable subsequent identification of vendor solutions corresponding to the request.

At step 378, the referral platform stores the referral card and associated vendor solutions within a data storage system indexed according to a plurality of market sectors. In some implementations, the referral card may be stored such that it may be identified and evaluated during subsequent searches performed by the referral platform in response to requests for vendor solutions.

At step 379, the referral platform stores one or more attributes associated with the referral card creator within the referral card data structure for use in determining a credibility weighting applied to the referral card during subsequent identification of vendor referrals. For example, the referral card creator identifier or other attributes associated with the referral source may be stored such that credibility weightings associated with the referral source may be applied when evaluating referral cards during vendor identification operations.

FIG. 3D illustrates an example process flow associated with identifying vendor referrals using referral cards stored within the referral platform. The process flow may be performed by the referral platform 100, for example through execution of instructions by the processing system 110 and interaction with the data storage system 120.

At step 380, the referral platform receives input defining a request for a vendor solution. The input may include a description of a problem to be solved or other attributes associated with the request. The request may be received through a platform interface or other communication mechanism that enables users of the referral platform to search for vendor solutions.

At step 382, the referral platform identifies a market sector associated with the request for the vendor solution. Identification of the market sector may be based on one or more attributes associated with the request. For example, the referral platform may analyze the description of the problem to be solved or other contextual attributes associated with the request to determine a market sector corresponding to the request.

In some implementations, identification of the market sector may include performing topic analysis or keyword analysis of the description of the problem to be solved and other attributes associated with the request.

At step 384, the referral platform searches referral cards stored in the data storage system and indexed according to the plurality of market sectors to identify referral cards associated with vendor solutions corresponding to the request for the vendor solution. For example, the referral platform may identify referral cards associated with vendor solutions stored within a market sector corresponding to the request.

In some implementations, multiple referral cards associated with a same vendor solution may be identified during the searching.

At step 386, the referral platform determines a referral score for each of the referral cards identified during the searching. The referral score may be determined based on one or more attributes stored in the referral card data structures. For example, determining the referral score may include applying a credibility weighting associated with an identifier of a referral card creator or other referral source associated with the referral card.

In some implementations, referral scores may also be influenced by attributes associated with referral contacts, contact roles associated with referral contacts, or contextual attributes associated with the request.

At step 388, the referral platform provides vendor solutions associated with the identified referral cards ranked according to the determined referral scores. The referral platform may provide the vendor solutions and associated referral information as output through a results interface or other output mechanism.

In some implementations, the output may include vendor solutions provided together with identifiers or contact information associated with referral card creators or referral contact persons capable of facilitating access to the vendor solutions.

In some implementations, when multiple referral cards correspond to a same vendor solution, referral scores associated with the respective referral cards may be aggregated or otherwise evaluated to influence ranking of the vendor solution. The referral platform may therefore identify vendor solutions that are supported by multiple referral sources and rank such vendor solutions higher than when ranked based on a single referral card.

In some implementations, the referral platform may receive outcome information associated with referrals generated through the platform. For example, vendors associated with vendor solutions may provide feedback indicating acceptance or rejection of a referral or completion of a transaction associated with the referral. Such outcome information may be used by the referral platform to update referral cards or adjust credibility weightings associated with referral sources. In some implementations, the referral card stored in the data storage system may be updated to indicate an approval status or rejection status associated with the referral card.

FIGS. 4A-4E illustrate visual representations of example graphical user interfaces of a referral platform described herein.

FIG. 4A illustrates an example referral creation interface 400. In the illustrated example, input fields include referral card creator 402 (which may be auto-filled based on the user accessing the referral platform), description of problem to be solved 404, timeline 406, budget 408, and description of contact role 410 (for example a role associated with an organization requesting the vendor solution). It should be understood that more or fewer fields can be provided. For example, fields for identifying a vendor solution or vendor organization can be included.

In the referral creation interface 400, a command button (“create” 412) can be included to direct the referral platform to generate a referral card based on the information input to the interface. Other command buttons can be included, such as update card or rate card. In some implementations, selection of the “create” 412 command button can cause the referral platform to initiate a search for vendor solutions corresponding to the input information.

FIG. 4B illustrates an example user interface 415 including a search bar 416. In the illustrated example, the search bar 416 may be provided on a page or view 418 of the referral platform. For example, a user may browse vendor solutions stored by the referral platform and submit a search request using the search bar 416. The search request may include a description of a problem to be solved or other attributes associated with a request for a vendor solution.

FIG. 4C illustrates an example results page 420. In the illustrated example, three vendor solutions 422A, 422B, and 422C are shown as results of a search request associated with a description of a problem to be solved. The results page may be generated in response to the “create” command button 412 of interface 400 or in response to input entered in search bar 416 of interface 415.

Navigation to pages providing additional details of a vendor solution may be possible from the results page (e.g., by a “view” 424 command button). In addition, a user may select one of the vendor solutions, for example by a “select” 426 command button. Also shown in the example results page 420 is a “refine” 428 command button, which can enable refinement of the search using filters or additional search parameters.

FIG. 4D illustrates a referral creation page 430 that may be displayed as a result of selecting the “select” command button 426 of FIG. 4C. In the illustrated example, the vendor solution that has been selected (e.g., solution 422C) is shown on the referral creation page 430. Information associated with the search request, such as the description of the problem to be solved, may be displayed or pre-populated within the referral creation page.

FIG. 4E illustrates an example user interface 440 including fields for entering refinements to a search request. In the illustrated example, refinements may include company stage 442, technology category 444, geographic region 446, and budget information 448. More or fewer refinements can be included, and the fields may be implemented as freeform input fields, selectable lists, or dropdown menus.

FIG. 5 illustrates a visual representation of an example referral card creation interface 500 that can trigger referral card generation or search operations within the referral platform. In the example implementation shown in FIG. 5, the description of the problem to be solved is “non-human identity needed for managing servers” 502 with a timeline of Q2-2026 for lab 504 and a budget of $50k year one 506. The contact role is indicated as CISO (chief information security officer) 508.

If a vendor identifier 510 is not specified, selection of the “create” command button 550 may initiate a search for vendor solutions corresponding to the request. If a vendor identifier 510 is specified, the referral platform may generate and store a referral card associated with the vendor solution,

In some implementations, vendors may be notified of referral cards associated with their vendor solutions and may view referral information through the referral platform. In some implementations, the referral platform may apply scoring or weighting techniques associated with referrals, and vendors may be presented with indicators or scores that assist in evaluating potential referrals. Such indicators may include information associated with the referral card creator or referral contacts associated with the referral card.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A referral platform for generating and identifying vendor referrals utilizing referral card data structures, the referral platform comprising:
a processing system comprising one or more processors and one or more computer-readable storage media; and
a data storage system storing vendor solutions and referral cards, wherein instructions stored on the one or more computer-readable storage media, when executed by the processing system, cause the referral platform to:
generate referral cards by receiving input associated with a referral card creator defining requests for vendor solutions, each referral card comprising a data structure including a plurality of attributes associated with a corresponding request for a vendor solution and an identifier of the referral card creator;
associate the referral cards with vendor solutions stored in the referral platform based on at least one market sector of a plurality of market sectors identified from one or more attributes stored in the referral card data structures;
store the referral cards and associated vendor solutions in the data storage system indexed according to the plurality of market sectors;
in response to subsequent requests for vendor solutions, search the stored referral cards indexed in the data storage system according to the plurality of market sectors to identify vendor solutions associated with referral cards corresponding to the requests;
determine, for each of the referral cards identified from the searching, a referral score based on one or more attributes stored in the referral card data structures, including applying a credibility weighting associated with the identifier of the referral card creator; and
provide the identified vendor solutions and associated referral cards ranked according to the referral scores.

2. The referral platform of claim 1, wherein the instructions further cause the referral platform to identify a plurality of referral cards associated with a same request for the vendor solution and determine the referral scores for the plurality of referral cards to identify a referral card having a highest likelihood of success in facilitating the vendor solution.

3. The referral platform of claim 1, wherein the credibility weighting associated with the identifier of the referral card creator is adjusted based on feedback received from vendors regarding outcomes of prior referrals associated with the referral card creator.

4. The referral platform of claim 1, wherein the plurality of attributes stored in the referral card data structures further include a tagged identifier associated with a referral contact person having a relationship with a vendor associated with the vendor solution, and wherein the instructions further cause the referral platform to store the referral cards in the data storage system such that the referral cards are searchable and retrievable by users of the referral platform other than the referral card creator.

5. The referral platform of claim 1, wherein the plurality of attributes stored in the referral card data structures further include at least one of:
a timeline associated with the request for the vendor solution,
a budget associated with the request for the vendor solution, and
a contact role associated with an organization requesting the vendor solution.

6. The referral platform of claim 1, wherein the market sector associated with the request for the vendor solution is identified by performing a topic analysis of one or more attributes stored in the referral card data structure.

7. The referral platform of claim 1, wherein vendor solutions stored in the referral platform include associated data comprising at least one of geographic location, company stage, or project stage.

8. The referral platform of claim 1, wherein the instructions further cause the referral platform to filter or calibrate vendor solutions identified from the searching based on a company stage associated with the vendor solutions.

9. The referral platform of claim 1, wherein the plurality of attributes stored in the referral card data structures further include a description of a problem to be solved associated with the request for the vendor solution, and wherein the description of the problem to be solved corresponds to the vendor solutions provided as results.

10. The referral platform of claim 1, wherein the instructions further cause the referral platform to interface with one or more external enterprise systems to obtain information associated with vendor solutions or referral contacts, the external enterprise systems including at least one of a contact management system, a vendor relationship management system, or a customer relationship management system.

11. A computer-implemented method for generating vendor referrals in a structured referral platform utilizing referral card data structures, the method comprising:
receiving input associated with a referral card creator defining a request for a vendor solution;
generating a referral card based on the received input, the referral card comprising a data structure including a plurality of attributes associated with the request for the vendor solution and an identifier of the referral card creator;
identifying, based on one or more attributes stored in the referral card data structure, a market sector associated with the request for the vendor solution;
associating the referral card with vendor solutions stored in the referral platform based on the identified market sector;
storing the referral card and the associated vendor solutions in a data storage system indexed according to a plurality of market sectors; and
storing one or more attributes associated with the referral card creator in the referral card data structure for use in determining a credibility weighting applied to the referral card during subsequent identification of vendor referrals.

12. The computer-implemented method of claim 11, wherein the plurality of attributes stored in the referral card data structure further include a description of a problem to be solved associated with the request for the vendor solution and a tagged identifier associated with a referral contact person having a relationship with a vendor associated with the vendor solution.

13. The computer-implemented method of claim 11, wherein the plurality of attributes stored in the referral card data structure further include at least one of a timeline associated with the request for the vendor solution, a budget associated with the request for the vendor solution, or a contact role associated with an organization requesting the vendor solution, and wherein the referral card is structured to include the timeline, budget, or contact role as fields usable in associating the referral card with vendor solutions stored in the referral platform.

14. The computer-implemented method of claim 11, further comprising receiving, at the referral platform, an approval or rejection of the referral card from a vendor associated with the vendor solution based on an evaluation of the referral card, and updating the referral card stored in the data storage system to indicate an approval status or rejection status associated with the referral card.

15. The computer-implemented method of claim 11, wherein identifying the market sector associated with the request for the vendor solution comprises performing a topic analysis of one or more attributes stored in the referral card data structure.

16. A computer-implemented method for identifying vendor referrals in a structured referral platform utilizing referral card data structures, the method comprising:
receiving input defining a request for a vendor solution;
identifying, based on one or more attributes associated with the request for the vendor solution, a market sector of a plurality of market sectors indexed in a data storage system of the referral platform;
searching referral cards stored in the data storage system and indexed according to the plurality of market sectors to identify referral cards associated with vendor solutions corresponding to the request for the vendor solution;
determining, for each of the referral cards identified from the searching, a referral score based on one or more attributes stored in the referral card data structures, including applying a credibility weighting associated with an identifier of a referral card creator associated with each referral card; and
providing vendor solutions associated with the identified referral cards ranked according to the referral scores.

17. The computer-implemented method of claim 16, wherein the request for the vendor solution includes a description of a problem to be solved, and wherein the referral platform identifies the market sector associated with the request by performing a topic analysis of the description of the problem to be solved and one or more additional attributes associated with the request, the additional attributes including at least one of a timeline associated with the request, a budget associated with the request, or a contact role associated with an organization requesting the vendor solution, and wherein the referral score for each referral card is determined based at least in part on the description of the problem to be solved and the credibility weighting associated with the referral card creator.

18. The computer-implemented method of claim 16, wherein a plurality of referral cards associated with a same vendor solution are identified during the searching, the method further comprising:
determining a respective referral score for each of the plurality of referral cards based on attributes stored in the referral card data structures including identifiers of respective referral card creators or referral contact persons;
aggregating the referral scores associated with the plurality of referral cards; and
ranking the vendor solution based on the aggregated referral scores such that the vendor solution is ranked higher than when ranked based on a single referral card.

19. The computer-implemented method of claim 16, further comprising:
identifying, for each vendor solution identified from the searching, a referral card creator or referral contact person associated with a referral card corresponding to the vendor solution; and
providing, as output of the referral platform, the vendor solutions together with contact information for the referral card creators or referral contact persons capable of facilitating access to the vendor solutions.

20. The computer-implemented method of claim 16, further comprising:
receiving, from a vendor associated with a vendor solution identified from the searching, an outcome indication corresponding to a referral card, the outcome indication including at least one of an acceptance of the referral, a rejection of the referral, or completion of a transaction associated with the referral; and
updating the referral card stored in the data storage system based on the outcome indication.
